(19) United States
(12) Patent Application Publication
(10) Pub. No.: US 2016/0158856 A1
(43) Pub. Date: Jun. 9, 2016

(54) CFRP Saw Blade

(71) Applicant: WIKUS-Saegenfabrik Wilhelm H. Kullmann GmbH & Co. KG, Spangenberg (DE)

(72) Inventor: Joerg H. Kullmann, Spangenberg (DE)

(21) Appl. No.: 15/019,420

(22) Filed: Feb. 9, 2016

Related U.S. Application Data
(63) Continuation of application No. PCT/EP2013/068001, filed on Aug. 30, 2013.

(51) Int. Cl. B23D 55/06; B23D 65/00; B23D 55/08; B23D 61/12; B23D 61/02; B27B 13/08

(52) U.S. Cl. CPC B23D 55/065; B23D 61/026; B27B 13/08; B23D 55/082; B23D 61/125; B23D 65/00

(57) ABSTRACT

During manufacture of a saw blade (1), especially a circular saw blade (2) or a saw band (14), the size of a deepening (8) in a tooth supporting body (3) of the saw blade (1) is reduced. The tooth supporting body (3) is then connected to a basic body (10) made of a fiber reinforced material to form the base body (12) of the saw blade (1) such that the deepening (8) is closed and the tooth supporting body (3) subjects the basic body (10) to tension when the tooth supporting body (3) and the basic body (10) have the same temperature.

### CROSS REFERENCE TO RELATED APPLICATIONS

This application is a continuation application of International Application number PCT/EP2013/068001 filed on Aug. 30, 2013.

### FIELD OF THE INVENTION

The present invention relates to a saw blade and a method of producing it. The saw blade includes a tooth supporting body, a plurality of teeth being located at the tooth supporting body and a basic body made of a fiber reinforced material.

The saw blade may be especially designed as a circular saw blade, a hacksaw blade, a machine saw blade, a reciprocating saw blade or a jig saw blade. The tooth supporting body and the tooth base are preferably made of metal, especially tempered steel. The cutting portion and at least another portion of the tooth tip of the teeth are also made of metal, especially of alloyed tool steel or high-speed tool steel, or of abrasive cutting materials such as carbide, cermet, ceramic cutting materials or diamond. This material is harder than the material of the tooth supporting body resulting in the saw blade being especially suitable for sawing metal materials. The teeth may include a hard material coating resulting in an increase of wear resistance. However, it is also possible to saw other materials, especially wood, with such saw blades.

### BACKGROUND OF THE INVENTION

A circular saw blade including a tooth supporting body, a plurality of teeth being arranged at the tooth supporting body and a basic body being made of a fiber reinforced material are known from European patent application No. EP 0 523 260 A1. The tooth supporting body is designed as an annular body having a central opening, the opening being closed by a disc-shaped basic body. The fibers of the basic body are directed at least approximately in a radial direction and to be uniformly distributed about the circumference of the basic body. It is desired that the fibers are embedded in the plastic material in a tight way, i.e. under a specific tensile stress being at least low and being identical for all fibers. It is intended to use a special wrapping and laying technique for this purpose.

In the course of this, the fibers are laid by winding them about fixing pins being distributed about the circumference and possibly about a fixing pin being located in the center portion. This winding about takes place under a constant tensile stress acting upon the fiber material. The document does not disclose how it is possible to transmit tensile forces by these glass fibers or carbon fibers. Due to this special winding technique, the disc body has a greater thickness in its radial inward portion than in its radial outward portions.

Another saw blade in the form of a circular saw blade or of a gang saw blade is known from European patent application No. EP 0 356 923 A1 corresponding to U.S. Pat. Nos. 5,465,706, 5,408,983 and 5,249,566. The saw blade at its outer rim carries a cutting layer of diamond or carbide which is divided into separate segments. The saw blade consists of a fiber reinforced plastic material including carbon fibres or graphite fibers. The cutting segments include holders being partly embedded in the plastic material of the saw blade. The fiber reinforced plastic material is arranged in the form of webs in one or more layers.

A reciprocating saw blade having a plurality of layers is known from European patent application No. EP 1 106 318 A2. The saw blade includes a metal core and two layers of fiber glass which are fixed on both sides of the metal core.

A saw band is known from U.S. Pat. No. 5,881,610. The saw band may include multiple layers of fiber material being connected to one another.

### ADDITIONAL BACKGROUND

A grinding wheel having a supporting body, an intermediate ring and a grinding ring is known from German utility model DE 201 02 684 U1. The intermediate ring is glued to the supporting body and/or the grinding ring. The supporting body consists of a steel disc or a steel ring. The grinding ring mainly consists of CBN (CBN=cubic boron nitride) or diamond. The intermediate ring is arranged between the grinding ring and the high-strength supporting body, the intermediate ring preferably being made of CFRP (CFRP=carbon fiber reinforced plastic).

### SUMMARY OF THE INVENTION

The new method serves to produce a saw blade including a tooth supporting body at which a plurality of teeth is arranged or will be arranged and a basic body made of a fiber reinforced material. The tooth supporting body includes a deepening the size of which is reduced in a method step. The tooth supporting body is connected to the basic body to form the base body of the saw blade such that the deepening is closed and the tooth supporting body subjects the basic body to tension when the tooth supporting body and the basic body have the same temperature.

The invention also relates to a saw blade including a tooth supporting body and a basic body. A plurality of teeth is arranged at the tooth supporting body. The tooth supporting body includes a deepening. The basic body is made of a fiber reinforced material which has been connected to the tooth supporting body under a reduction of the size of the deepening of the tooth supporting body to form the base body of the saw blade such that the deepening is closed and the tooth supporting body subjects the basic body to tension when the tooth supporting body and the basic body have the same temperature.

The invention also relates to a saw band including an elongated tooth supporting body at which a plurality of teeth is arranged and which includes a deepening. The saw band further includes a basic body made of a fiber reinforced material and being connected to the tooth supporting body to form the base body of the saw band such that the deepening is closed.

The invention also relates to a band saw machine including a saw band. The saw band includes an elongated tooth supporting body at which a plurality of teeth is arranged and which includes a deepening. The saw band further includes a basic body made of a fiber reinforced material and being connected to the tooth supporting body to form the base body of the saw band such that the deepening is closed. The band saw machine further includes a two wheels via which the saw band is guided and rotatingly driven, the distance between the wheels being designed to be adjustable such that the tooth supporting body subjects the basic body to tension when the tooth supporting body and the basic body of the saw band have the same temperature.

With the novel method, it is possible to provide a saw blade which has an extended tool life and which supplies an improved surface quality of the cut material.

### DEFINITIONS

Saw blade: A saw blade is to be understood in this application as an elongated saw band, a reciprocating saw blade, a circular saw blade or any other possible type of a saw blade.

Tooth supporting body: The tooth supporting body is to be understood in this application as the part of the saw blade at which the teeth of the saw blade are arranged. This is also often designated as the “base body” of the saw blade. The term “tooth supporting body” is however intended to better express that this is the part of a saw blade which itself cannot be designated as a tooth, but instead the part at which the teeth are arranged. It is to be taken into account that there are differences between the functional and the material differentiation between the tooth supporting body and the teeth. Functionally, the tooth begins with its tooth base in the region of the tooth gullet. This tooth base however is often made of the same material as the tooth supporting body, and it is designed as one piece therewith. In other words, a part of this material fulfills the function of the tooth supporting body, and another part fulfills the function of the tooth base and thus of the tooth. The differentiation with respect to the material is then realized further away from the tooth supporting body in the region of the tip of the tooth.

Deepening of the tooth supporting body: The deepening of the tooth supporting body is to be understood in this application as a circumferentially closed or circumferentially open deepening, opening, through hole or recess. This deepening is then at least partly closed by the basic body. In case the tooth supporting body is a ring having a central opening, for example, the deepening is to be understood as this opening of the ring.

### FURTHER DESCRIPTION

Thus, in the new hybrid saw blade including a tooth supporting body especially made of metal and a basic body made of a fiber reinforced material, the tooth supporting body is treated in a special way such that the size of its deepening is reduced. In the finished condition of the saw blade in which the deepening of the tooth supporting body is then at least partly closed by the basic body, the tooth supporting body subjects the basic body to tension.

The tensional force is chosen such that the desired stiffness values are reached without negatively influencing the shape of the saw blade. A tensional force being too low generally leads to a base body not having sufficient structural stiffness. A tensional force being too great would result in undesired torsion of the base body. The tensile load reduces the natural frequency behavior of the saw blade, i.e. its natural frequency is changed such that it does not coincide with the frequencies acting from the outside during sawing, and thus there is no resonance.

Due to the hybrid construction, the advantages of the different materials are combined in a special way. The teeth can be connected to the tooth supporting body by a suitable method. The fiber reinforced material of the basic body provides outstanding stiffness values, a low mass and, at the same time, very good attenuation properties. Due to the great stiffness and the improved attenuation characteristics, there are less vibrations when sawing with the new saw blade compared to the prior art. This results in an improved straight movement. In this way, the surface quality of the cut material is improved and wear of the teeth of the saw blade is reduced. In this way, the usable lifetime is increased. Due to the reduced vibrations, the cutting forces and noise emissions are reduced. Due to the reduced rotating mass of the saw blade, energy consumption during sawing is reduced.

The reduction of the seize of the deepening can be realized by selective heat treatment for realizing a temperature difference between the basic body and the tooth supporting body. Especially, the tooth supporting body is cooled such that its diameter and especially its inner diameter is reduced. Thus, the diameter or size of the deepening is reduced. Such a method is also designated as cold stretching. During this, the tooth supporting body can be cooled to reach a temperature of less than −5° C., especially between approximately −10 and −20° C. For example, cooling can be realized by liquid nitrogen. The tooth supporting body is mechanically fixed in this shrunk position such that it cannot expand to its starting size even after cooling has ended and it has been reheated.

If in the following the tooth supporting body is then fixedly connected to the basic body of the fiber reinforced material and the fixation is released, the tooth supporting body expands due to the rising temperature and thus exerts a tensile stress to the basic body. This tensile stress is very important for the correct functionality of the basic body of fiber reinforced material since such fiber reinforced materials can be subjected to tension, but not, or only limited, to pressure and bending. Due to the pre-adjusted tensile stress, it is thus ensured that even during compressive forces acting upon the base body from the outside, the saw blade is still subjected to tension.

For producing the basic body, especially the so called RTM method (RTM=Resin Transfer Molding) can be used during which the fibers are infiltrated by a resin in a closed mold under vacuum. A catalyst is required for starting the polymerization process. For example, such a catalyst can be an increased hardening temperature. For example, this temperature can be in a range of approximately 80° C. to 130° C.

During cooling of the tooth supporting body, the tooth supporting body is either cooled inside of the RTM mold or outside of the RTM mold. After cooling, the tooth supporting body is fixed in the RTM mold such that the increase of the size of its deepening due to the increasing temperature is prevented. In the following, the basic body can be connected to the tooth supporting body and polymerization of the matrix material of the basic body can be conducted without the tooth supporting body being capable of expanding. After hardening of the matrix material and the thus finished fixed connection between the tooth supporting body and the basic body as well as loosening the fixation of the tooth supporting body, the tooth supporting body expands and thus provides the desired tensile stress to the basic body.

Alternatively or additionally, hardening of the matrix material can also be realized not by a temperature increase, but instead by using suitable chemical substances starting the polymerization process. For example, these substances can be solvents.

Another possibility is hardening of the matrix material due to a microwave treatment or a UV light treatment.

Alternatively or additionally, the change of the size of the deepening can be attained by pressurization of the tooth supporting body. For this purpose, the tooth supporting body is minimally deformed by eccentric screws or hydraulic pressure, for example. The deformation may be especially between approximately 0.01 and 0.05 mm, preferably approximately 0.03 mm. During the hardening process of the matrix material, the tooth supporting body is then fixed in this position. After complete hardening of the matrix material and loosening of the fixation, it can re-expand and thus exerts the desired tensional force upon the basic body.

The fiber reinforced material may include reinforced fibers and a matrix material, the fibers being arranged in the matrix material as a tow such that a quasi isotropic fabric is formed. The reinforced fibers may be metal fibers, carbon fibers and/or plastic fibers and/or the matrix material may include plastic, ceramic and/or metal. In a preferred embodiment, the fiber reinforced material is CFRP (CFRP=carbon fiber reinforced plastic).

The basic body may include a plurality of tows of the fiber reinforced material, the tows being connected to the tooth supporting body such that a connecting element of the tooth supporting body is arranged between a plurality of tows and the tows are connected to one another via recesses being located in the connecting element. In this way, the connection between the basic body and the tooth supporting body due to force-fit and form-fit is realized. Due to the plurality of tows being combined with one another, a fabric is realized having quasi isotropic properties. The fibers in one tow are preferably oriented in the same way, and they are oriented differently in different tows. Especially, the tows are located on one another at a specific twisted angle.

The tooth supporting body may include a thicker tooth element in its outer region and a thinner connecting element in its inner region. The radial width of the tooth element may be approximately 20 mm, for example, and it may have a thickness of approximately 1.5 to 5 mm, especially approximately 2.25 mm. The connecting element may also have a radial width of approximately 20 mm, and it is preferably designed to be stepped in both directions such that, for example, in case the thickness of the tooth element is 2.25 mm, there is a connecting element having a thickness of approximately 0.8 mm.

The saw blade may be designed as a circular saw blade and the tooth supporting body may be designed to be annular. In this case, the diameter of the annular tooth supporting body is reduced and the tooth supporting body subjects the basic body to tension in a radial direction. The diameter of the circular saw blade may be between approximately 100 to 3000 mm, for example. Its thickness may be between approximately 1 to 50 mm, for example.

In case the saw blade is designed as a circular saw blade, it may include a plurality of deepenings being distributed about the circumference. In each of these deepenings, a basic body is arranged. In this way, three, four, five, six, seven, eight or more basic bodies may be connected to the tooth supporting body.

Thus, the tooth supporting body may be especially designed to be spoke-like, the spokes being formed by metal and the deepenings being located in between. The deepenings are then closed by the fiber reinforced material.

However, the saw blade may also be designed as a saw band, and the tooth supporting body may be designed to be elongated. The height of the saw band (which is also designated as “band width”) may be between approximately 20 to 500 mm, for example. Its thickness may be between approximately 0.5 to 10 mm, for example.

The tooth supporting body may include protrusions each forming a part of the tooth. An insert is arranged at the protrusions, the insert being fixed by a screw connection and the insert being made of a material which is harder than the material of the protrusions. The inserts may also be connected to the protrusions by welding, soldering, brazing, clamping or plug-connecting or by a pin connection. The insert may be made of HSS, carbide, PCD, ceramic or CBN, for example.

The tooth supporting body may include anchoring bodies made of a material which is harder than the material of the tooth supporting body. In this way, the tooth supporting body may be made of a comparatively softer and cheaper material without losing the possibility of securely connecting the teeth.

The tooth supporting body, the tooth base and the tooth may, however, also be designed as one piece of metal, preferably high-speed metal.

Furthermore, in the embodiment of the saw blade being designed as a circular saw blade, there is the possibility of fixing segments of a circular arc on the annular tooth supporting body, the segments forming the tooth base and the tooth including the cutting portion.

The new hybrid saw blade is especially suitable for thin saw blades since, despite the low thickness of the saw blade, the required stiffness properties are provided due to the advantageous properties of the fiber reinforced material. Such thin saw blades are especially saw blades having a thickness of 1 to 4 mm, preferably 2.25 mm or 1.75 mm.

In the saw blade according to the invention being designed as an elongated saw band, the desired tensile force is attained after having mounted the saw band in the band saw machine. For this purpose, the band saw machine includes two wheels, the distance between these wheels being adjustable. This is often realized by one of the wheels being stationary and the other wheel being designed to be movable in a horizontal direction. In this way, the distance and the tensile force acting upon the saw band can be adjusted. The tensile stress may be approximately 300 N/mm², for example. This tensile stress is then also transmitted by the tooth supporting body to the base body being made of the fiber reinforced material such that the desired tensile stress in the longitudinal direction is realized.

Advantageous developments of the invention result from the claims, the description and the drawings. The advantages of features and of combinations of a plurality of features mentioned at the beginning of the description only serve as examples and may be used alternatively or cumulatively without the necessity of embodiments according to the invention having to obtain these advantages. Without changing the scope of protection as defined by the enclosed claims, the following applies with respect to the disclosure of the original application and the patent: further features may be taken from the drawings, in particular from the illustrated designs and the dimensions of a plurality of components with respect to one another as well as from their relative arrangement and their operative connection. The combination of features of different embodiments of the invention or of features of different claims independent of the chosen references of the claims is also possible, and it is motivated herewith. This also relates to features which are illustrated in separate drawings, or which are mentioned when describing them. These features may also be combined with features of different claims. Furthermore, it is possible that further embodiments of the invention do not have the features mentioned in the claims.

The number of the features mentioned in the claims and in the description is to be understood to cover this exact number and a greater number than the mentioned number without having to explicitly use the adverb “at least”. For example, if a deepening is mentioned, this is to be understood such that there is exactly one deepening or there are two deepenings or more deepenings. Additional features may be added to these features, or these features may be the only features of the respective product.

The reference signs contained in the claims are not limiting the extent of the matter protected by the claims. Their sole function is to make the claims easier to understand.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. In the drawings, like reference numerals designate corresponding parts throughout the several views.

FIG. 1 illustrates a top view of a first exemplary embodiment of the new saw blade being designed as a circular saw blade.

FIG. 2 illustrates a sectional view of the saw blade according to FIG. 1.

FIG. 3 illustrates a top view of a second exemplary embodiment of the saw blade being designed as a circular saw blade.

FIG. 4 illustrates a sectional view of the saw blade according to FIG. 3.

FIG. 5 illustrates a top view of a third exemplary embodiment of the saw blade being designed as a circular saw blade.

FIG. 6 illustrates a sectional view of the saw blade according to FIG. 5.

FIG. 7 illustrates a sectional view corresponding to FIG. 6 of a fourth exemplary embodiment of the saw blade being designed as a circular saw blade.

FIG. 8 illustrates a sectional view corresponding to FIG. 6 of a fifth exemplary embodiment of the saw blade being designed as a circular saw blade.

FIG. 9 illustrates a top view of a part of a first exemplary embodiment of the tooth supporting body.

FIG. 10 illustrates a top view of a part of a second exemplary embodiment of the tooth supporting body.

FIG. 11 illustrates a top view of a part of a third exemplary embodiment of the tooth supporting body.

FIG. 12 illustrates a top view of a part of a fourth exemplary embodiment of the tooth supporting body.

FIG. 13 illustrates a top view of a part of a fifth exemplary embodiment of the tooth supporting body.

FIG. 14 illustrates a top view of a part of a sixth exemplary embodiment of the tooth supporting body.

FIG. 15 illustrates a top view of a part of a seventh exemplary embodiment of the tooth supporting body.

FIG. 16 illustrates a top view of another exemplary embodiment of the saw blade being designed as a saw band.

FIG. 17 illustrates a top view of another exemplary embodiment of the saw blade being designed as a saw band.

FIG. 18 illustrates a sectional view of a first exemplary embodiment of the connection of an insert at a protrusion of the tooth supporting body to form a tooth.

FIG. 19 illustrates a sectional view of a second exemplary embodiment of the connection of an insert at a protrusion of the tooth supporting body to form a tooth.

FIG. 20 illustrates a sectional view of a third exemplary embodiment of the connection of an insert at a protrusion of the tooth supporting body to form a tooth.

FIG. 21 illustrates a top view of another exemplary embodiment of the tooth supporting body.

FIG. 22 illustrates a detailed view of the tooth supporting body according to FIG. 21.

FIG. 23 illustrates a top view of another exemplary embodiment of the tooth supporting body.

FIG. 24 illustrates a detailed view of the tooth supporting body according to FIG. 23.

FIG. 25 illustrates a top view of another exemplary embodiment of the tooth supporting body.

FIG. 26 illustrates a detailed view of the tooth supporting body according to FIG. 25.

FIG. 27 illustrates a top view of another exemplary embodiment of the tooth supporting body.

FIG. 28 illustrates a detailed view of the tooth supporting body according to FIG. 27.

FIG. 29 illustrates a top view of another exemplary embodiment of the tooth supporting body.

FIG. 30 illustrates a detailed view of the tooth supporting body according to FIG. 29.

FIG. 31 illustrates a top view of another exemplary embodiment of the tooth supporting body.

FIG. 32 illustrates a detailed view of the tooth supporting body according to FIG. 31.

FIG. 33 illustrates a sectional view of a part of another exemplary embodiment of the saw blade being designed as a circular saw blade.

FIG. 34 illustrates a sectional view of a part of another exemplary embodiment of the saw blade being designed as a circular saw blade.

FIG. 35 illustrates a sectional view of a part of another exemplary embodiment of the saw blade being designed as a circular saw blade.

FIG. 36 illustrates a sectional view of a part of another exemplary embodiment of the saw blade being designed as a circular saw blade.

FIG. 37 illustrates a sectional view of another exemplary embodiment of the saw blade being designed as a circular saw blade.

FIG. 38 illustrates a sectional view of another exemplary embodiment of the saw blade being designed as a circular saw blade.

FIG. 39 illustrates a sectional view of another exemplary embodiment of the saw blade being designed as a circular saw blade.

FIG. 40 illustrates a sectional view of another exemplary embodiment of the saw blade being designed as a circular saw blade.

### DETAILED DESCRIPTION

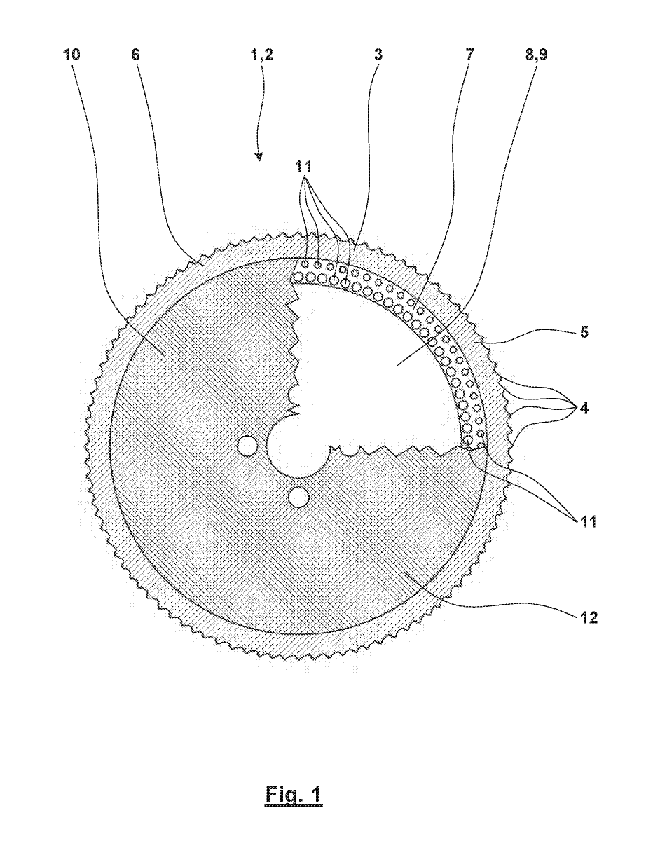

Referring now in greater detail to the drawings, FIG. 1 illustrates a top view of a first exemplary embodiment of the new saw blade 1. In this case, the saw blade 1 is designed as a circular saw blade 2. However, the saw blade 1 could also be of a different type as it is described herein below.

The saw blade 1 includes a tooth supporting body 3 at which a plurality of teeth 4 is arranged. The tooth supporting body 3 is preferably made of metal, and in the present case it is designed as a ring 5. The tooth supporting body 3 includes a tooth element 6, a connecting element 7 and a deepening 8. In the illustrated example, the deepening 8 is a continuous opening 9 extending over the entire thickness of the saw blade 1 such that the ring 5 is formed.

The saw blade 1 furthermore includes a basic body 10 made of a fiber reinforced material. The basic body 10 closes the deepening 8 of the tooth supporting body 3. In the present example, the deepening 8 is completely closed. The basic body 10 is illustrated partly broken away to make the connecting element 7 of the tooth supporting body 3 and the deepening 8 visible. In the present embodiment of the saw blade 1, the tooth supporting body 3 as well as the basic body 10 are designed to be rotationally symmetrical.

As it can be further seen well in FIG. 1, the connecting element 7 includes a plurality of recesses 11 serving for a fixed connection between the basic body 10 and the tooth supporting body 3 as this will be further described herein below. During manufacture of the saw blade 1, the tooth supporting body 3 is connected to the basic body 10 to form the base body 12 of the saw blade 1 in a way that the deepening 8 is closed and that the tooth supporting body 3 subjects the basic body 10 to tension. The tensile stress is chosen such that it does not only exist after possible heating of the saw blade 1, but instead already when the tooth supporting body 3 and the base body 10 have the same temperature—i.e. also at normal room temperature. Since it has already been described above how this tensile stress is realized, it is referred to these statements.

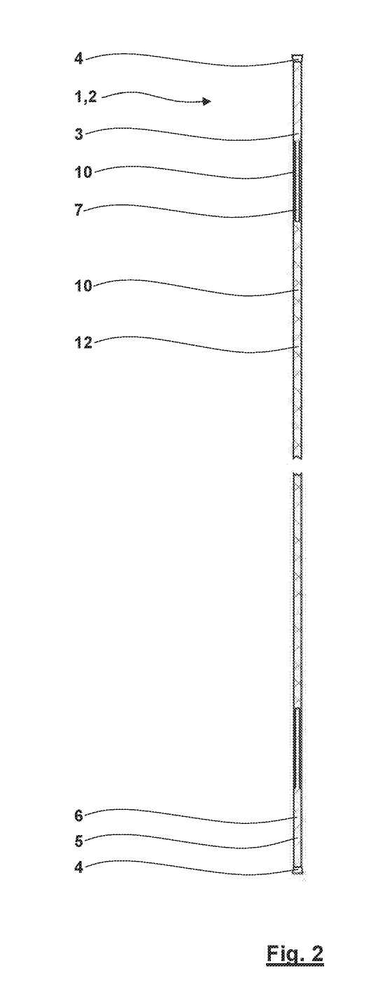

FIG. 2 illustrates a section through the saw blade 1 according to FIG. 1. It can be seen well there that the basic body 10 contacts the connecting element 7 of the tooth supporting body 3 from both sides and thus achieves the secure connection between the tooth supporting body 3 and the basic body 10. The basic body 10 being made of a fiber reinforced material includes reinforced fibers and a matrix material, the fibers being arranged as tow in the matrix material such that a fabric being quasi isotropic is formed. In this sense, at least one tow—preferably a plurality of tows—is connected from one side of the connecting element 7 to the connecting element 7 and the respective other tows and the matrix, respectively, and another tow —preferably a plurality of tows—from the other side of the connecting element. In this way, a fabric is formed, the fabric being fixedly connected to the tooth supporting body 3 and, in its hardened condition, being capable of accepting tensile forces being applied by the tooth supporting body 3.

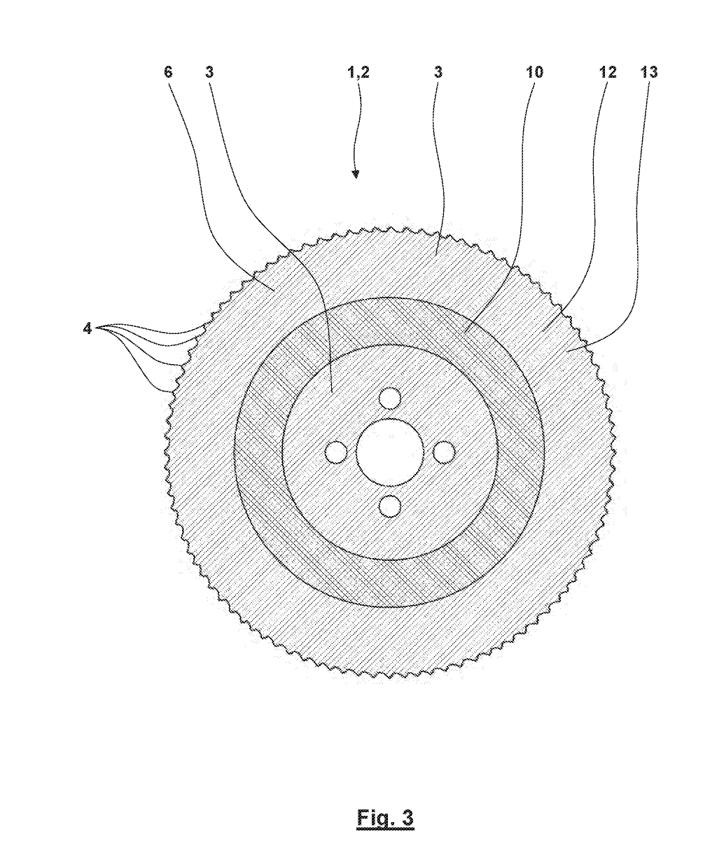

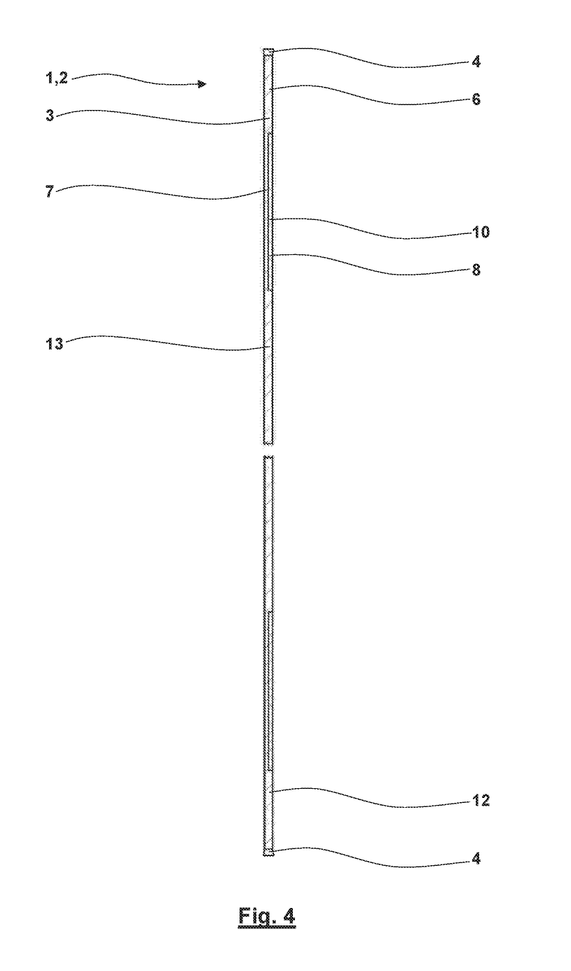

FIGS. 3 and 4 illustrate a second exemplary embodiment of the new saw blade 1 being designed as a circular saw blade 2. With respect to the corresponding features, it is referred to the above statements concerning FIG. 1. In contrast thereto, the tooth supporting body 3 is not designed as a ring 5, but instead as a disc 13. Correspondingly, the tooth supporting body 3 includes a deepening 8 not being designed as a continuous opening or impression, but instead as a deepening in the narrower sense. The basic body 10 is arranged in this deepening 8 such that it is subjected to tension by the tooth supporting body 3.

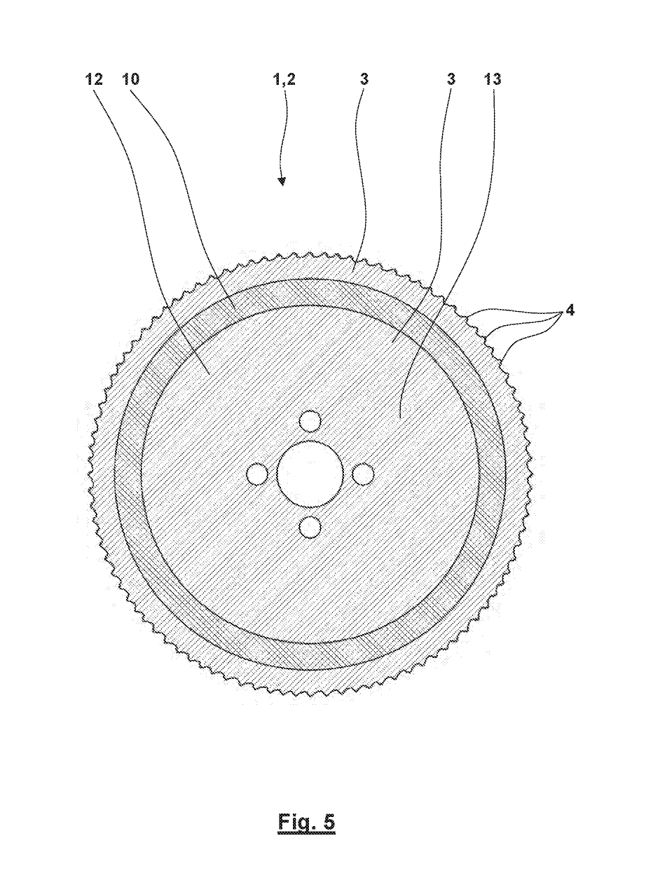

FIGS. 5 and 6 illustrate another exemplary embodiment of the saw blade 1 being designed as a circular saw blade 2. The tooth supporting body 3 is again designed as a disc 13. With respect to the corresponding features, it is referred to the above statements relating to the previous figures. In contrast to the saw blade according to FIGS. 4, 5, two annular deepenings 8 exist in the tooth supporting body 3, a base body 10 being arranged in each of these. The deepenings 8 are again not designed to be continuous in the sense of a through hole. They are located at the opposite sides of the saw blade 1 in a radial spaced apart manner.

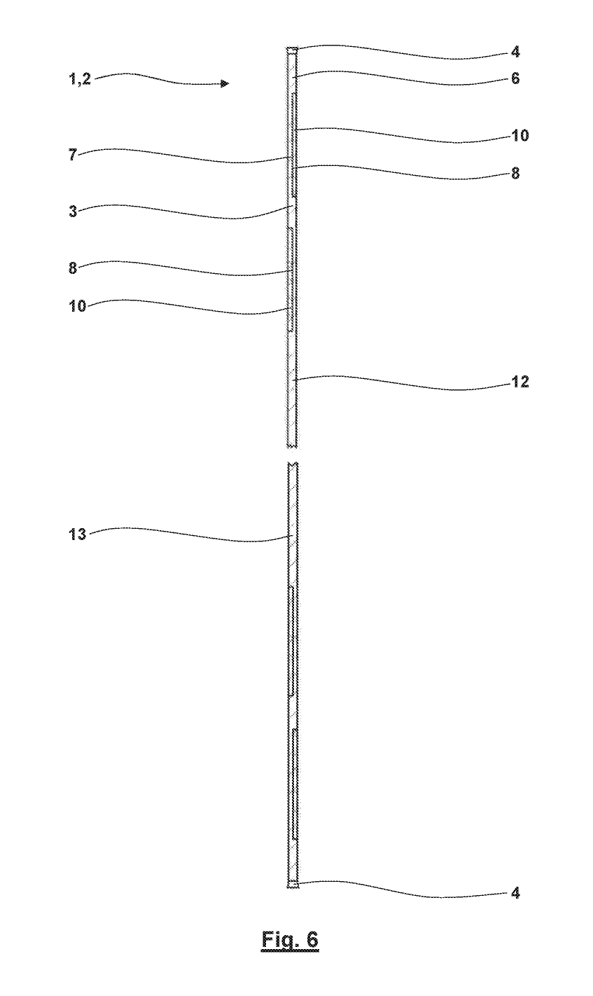

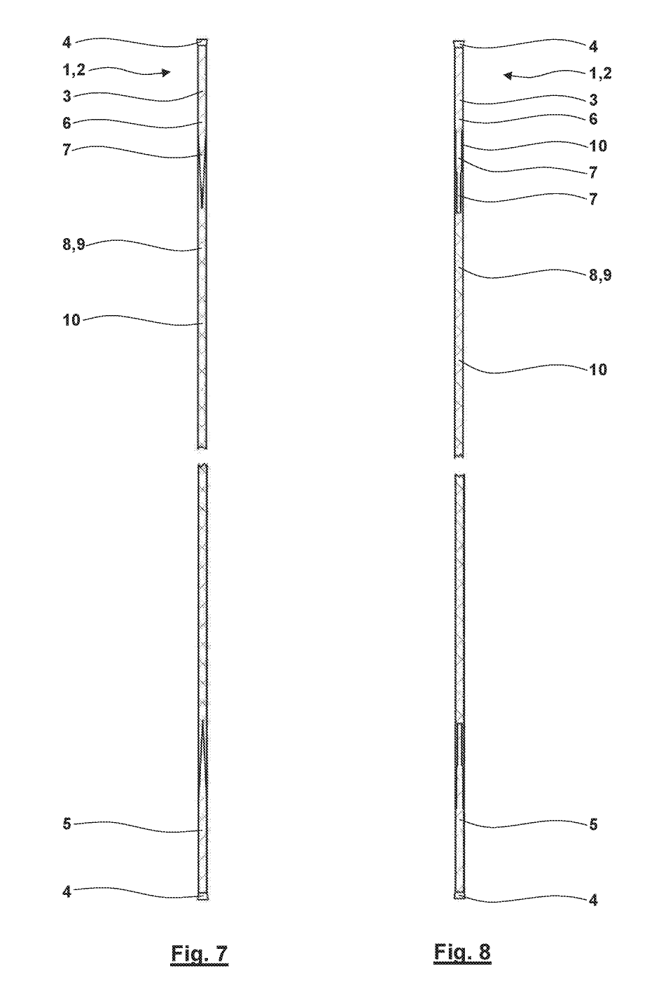

FIG. 7 illustrates a sectional view of another exemplary embodiment of the new saw blade 1, the sectional view corresponding to the previous sectional views. The saw blade 1 again is designed as a circular saw blade 2. With respect to the corresponding features, it is referred to the above statements. In the illustrated example, the tooth supporting body 3 is again designed as a ring 5, and it includes a deepening 8 being designed as a continuous opening 9. No perpendicular step, but instead a uniform transition is realized in the transition region between the tooth element 6 and the connecting element 7 of the tooth supporting body 3.

FIG. 8 illustrates a sectional view of another exemplary embodiment of the new saw blade 1, the sectional view corresponding to the previous sectional views. The saw blade 1 is again designed as a circular saw blade 2. With respect to the corresponding features, it is referred to the above statements. In contrast to FIG. 7, the tooth supporting body 3 includes two steps of different heights such that the connecting element 7 includes two different portions.

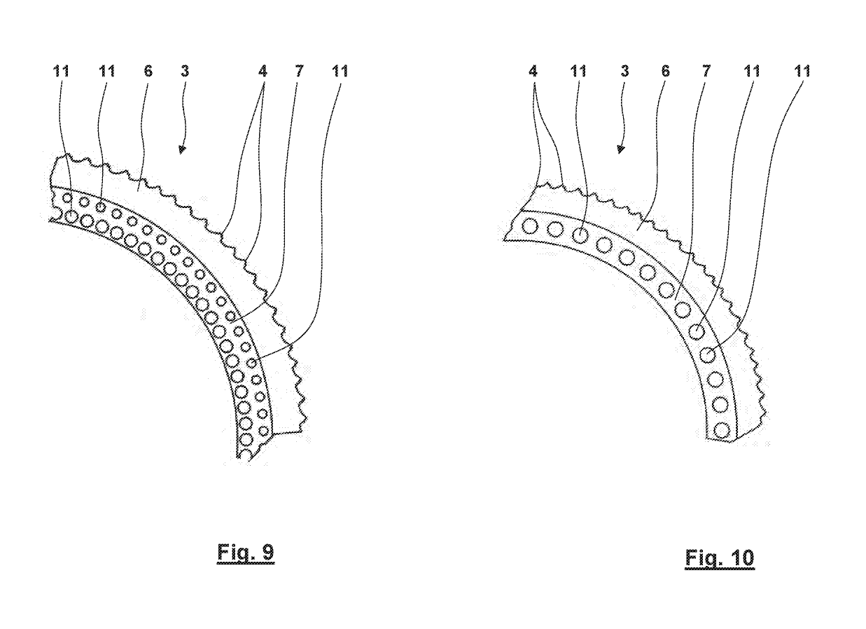

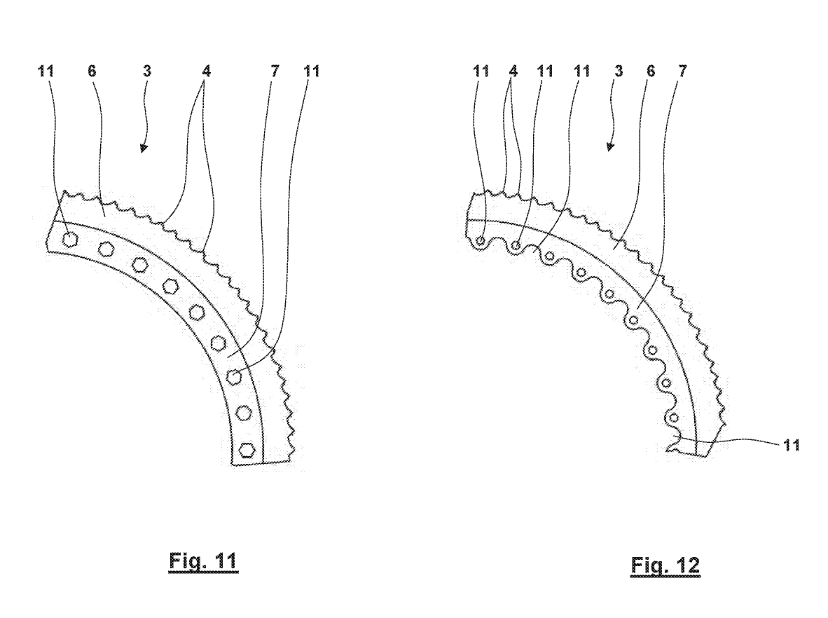

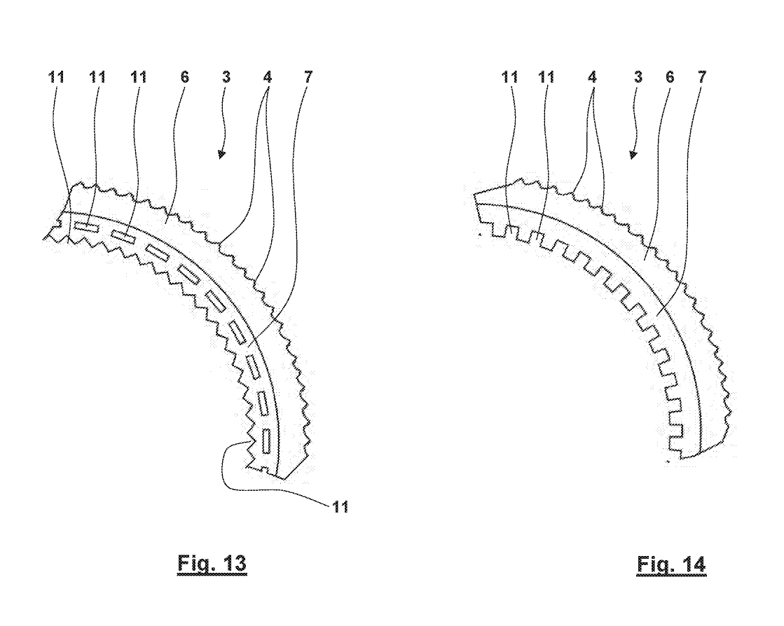

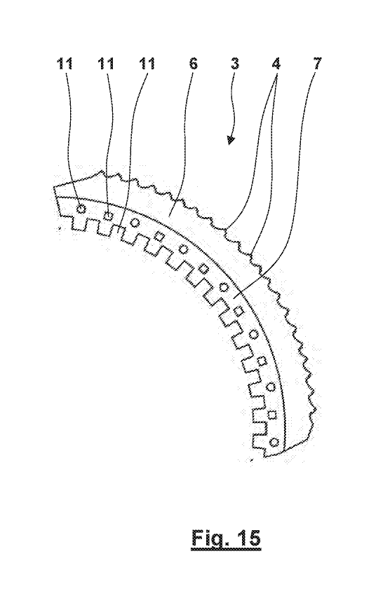

FIGS. 9 to 15 illustrate sections of different exemplary embodiments of the tooth supporting body 3 of a saw blade 1 being designed as a circular saw blade 2. The different embodiments differ with respect to the design and arrangement of the recesses 11. In the embodiment according to FIG. 9, the cross section of the recess 11 is circular, the recesses 11 having different diameters. In the embodiment according to FIG. 10, its cross section is also circular, but there only exists one row of recesses 11. In the embodiment according to FIG. 11, the recesses 11 have a hexagonal cross section. In the embodiment according to FIG. 12, a part of the recesses 11 is again circular and closed, while another part of the recesses 11 is designed as circumferentially open recesses 11. In the embodiment according to FIG. 13, a part of the recesses 11 has a rectangular cross section, while another part of the recesses 11 is again arranged in the edge portion of the tooth element 6 and is designed as circumferentially open recesses 11. In this case, in contrast to FIG. 12, the recesses 11 are not rounded, but instead they include straight portions. The embodiment according to FIG. 14 does not include circumferentially closed recesses, but instead only circumferentially open recesses 11. In this case, these recesses 11 are designed to be rectangular. FIG. 15 illustrates an exemplary embodiment of the tooth supporting body 3 in which once again the circumferentially open rectangular recesses 11 of FIG. 14 are used, but these are combined with round and rectangular circumferentially closed recesses 11.

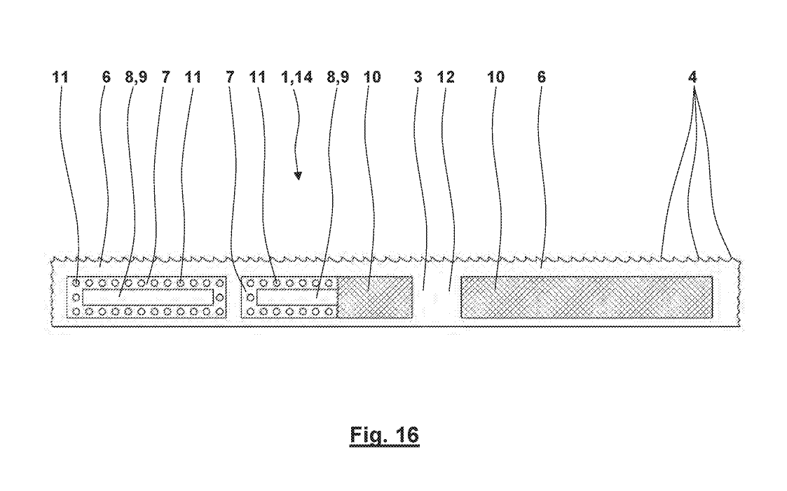

FIG. 16 illustrates another exemplary embodiment of the saw blade 1 being designed as a saw band 14. It is to be understood that only a section of the elongated saw band 14 is illustrated. The tooth supporting body 3 includes a plurality of deepenings 8 each being closed by a basic body 10. For clarification of the structure, the basic body 10 is not shown in the far left deepening 8 and is only partly shown in the middle deepening 8. It is to be understood that the saw band 14 looks the same way at these places as it is illustrated in the right portion of FIG. 16. The deepenings 8 are designed as continuous openings 9. However, they could also be non-continuous deepenings 8 in the narrower sense. Again, recesses 11 exist in the connecting element 7 to ensure the fixed connection of the basic body 10 and the tooth supporting body 3.

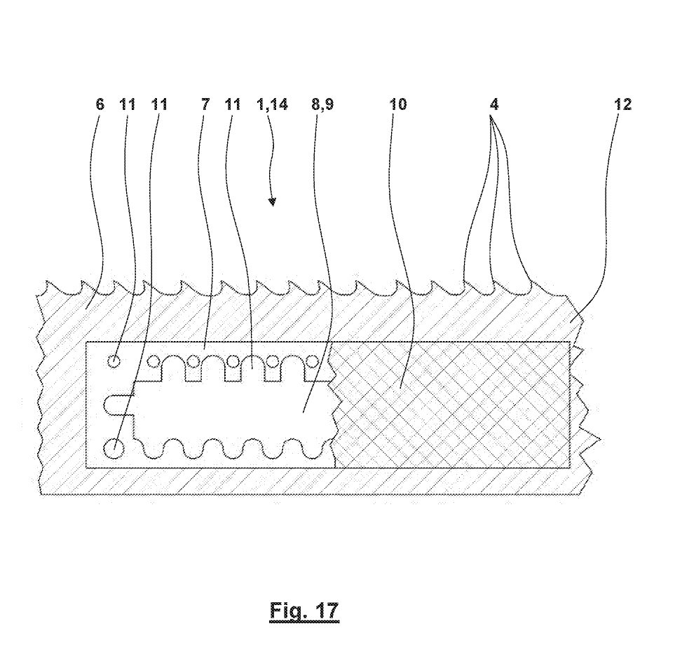

FIG. 17 illustrates a similar embodiment of the saw blade 1 being designed as a saw band 14. In this case, the design of the connecting element 7 is different. The connecting element 7 includes different types of recesses 11.

FIG. 18 illustrates a section of the tooth supporting body 3. The tooth supporting body 3 includes a protrusion 15 at which an insert 16 is fixed. The protrusion 15 and the insert 16 then form the tooth 4. The insert 16 is especially made of a material which is harder than the material of the protrusion 15. In the present case, the insert 16 is fixedly connected to the protrusion 15 by a pin connection including a pin 17.

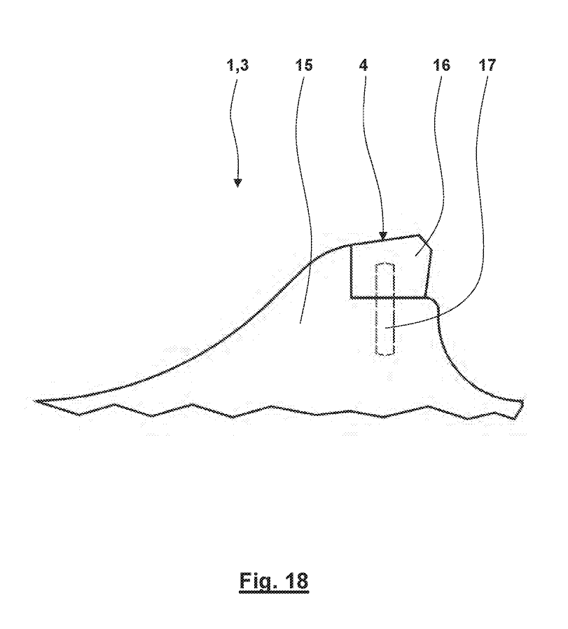

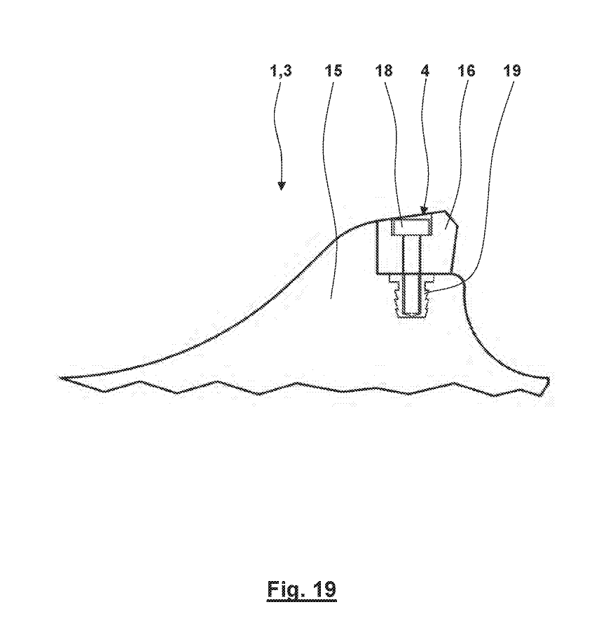

In the embodiment illustrated in FIG. 19, there is a screw connection instead of the pin connection. For this purpose, a screw 18 is provided, the screw 18 with its outer thread engaging into a corresponding inner thread of an anchoring body 19 being located in the protrusion 15. In this embodiment, the screw 18 is screwed into the insert 16 approximately from above.

FIG. 20 illustrates another exemplary embodiment of the tooth supporting body 3 with a similar general design as the one in FIG. 19, but the screw 18 is screwed into the insert 16 approximately from the front.

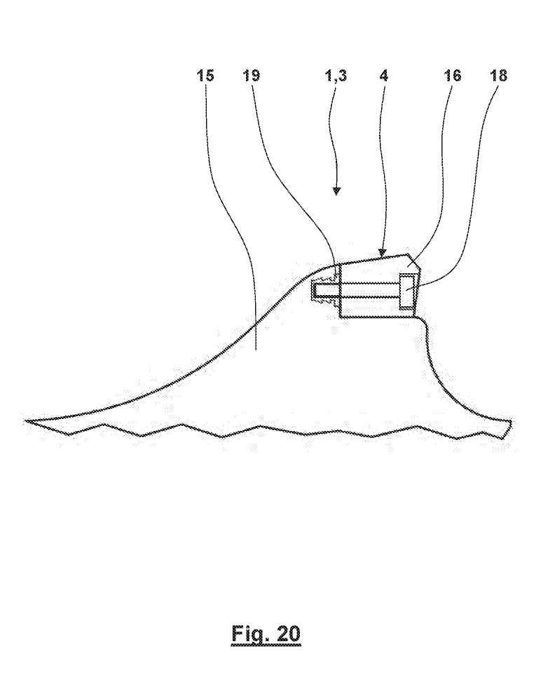

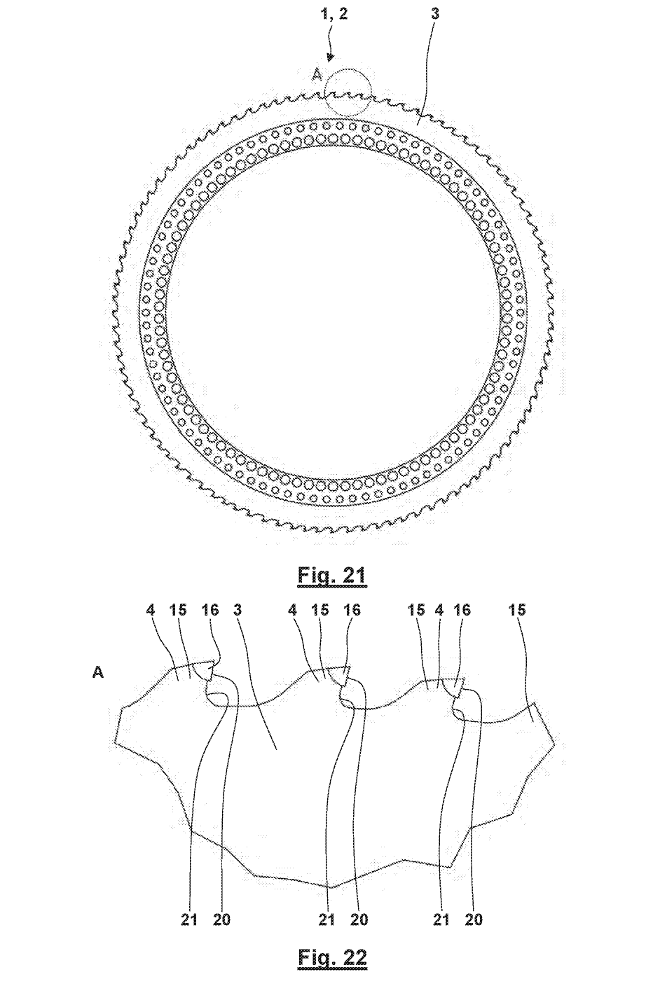

FIG. 21 illustrates a top view of another exemplary embodiment of the saw blade 1 being designed as a circular saw blade 2. FIG. 22 illustrates detail A of FIG. 21. The same applies accordingly to FIGS. 23 to 32.

Apart from that, these embodiments have a lot in common with the above described embodiments of the saw blade 1 such that it is referred to the above statements. Furthermore, due to these correspondences, not all reference numerals have been included in the figures.

These figures substantially serve to further describe the possible design of the teeth 4. These embodiments of the teeth 4 can also be applied to the above described saw blades 1 and to the saw blades 1 being illustrated in the other drawings.

As it is to be well seen in FIG. 22, the tooth supporting body 3 includes the protrusions 15. An insert 16 is fixedly connected to each of the protrusions 15. The insert 16 is made of a material which is harder than the material of the protrusion 15. In the present case, the insert 16 is fixedly connected to the protrusion 15 by a welding connection, a brazing connection or a soldering connection. There exists a projection of the chip producing surface 20 with respect to the chip space 21.

FIGS. 23 and 24 illustrate an embodiment of the teeth 4 being similar to the one in FIGS. 21 and 22. In contrast, the chip producing surface 20 is connected to the chip space 21 without a projection.

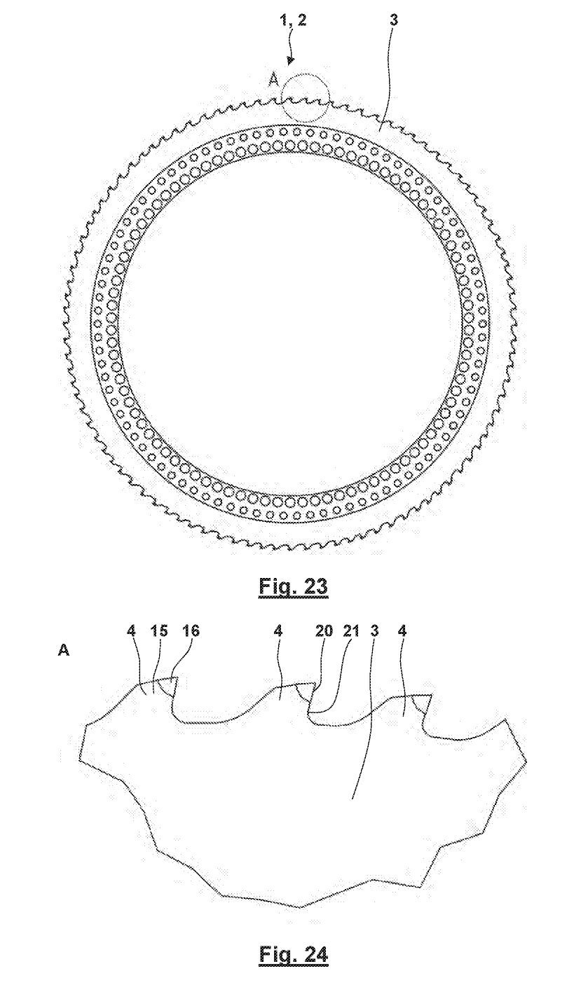

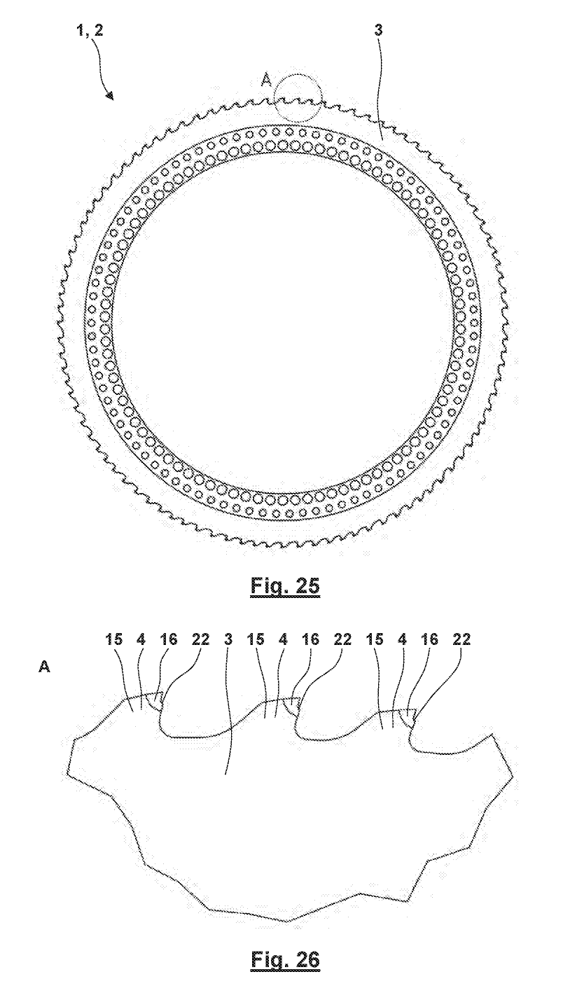

FIGS. 25 and 26 illustrate another exemplary embodiment of the saw blade 1 including teeth 4 each including a chip deforming element 22. The chip deforming element 22 is only arranged at the insert 16, and it does not extend over the protrusion 15. In this case, the inserts 16 are fixedly connected to the respective protrusion 15 by welding.

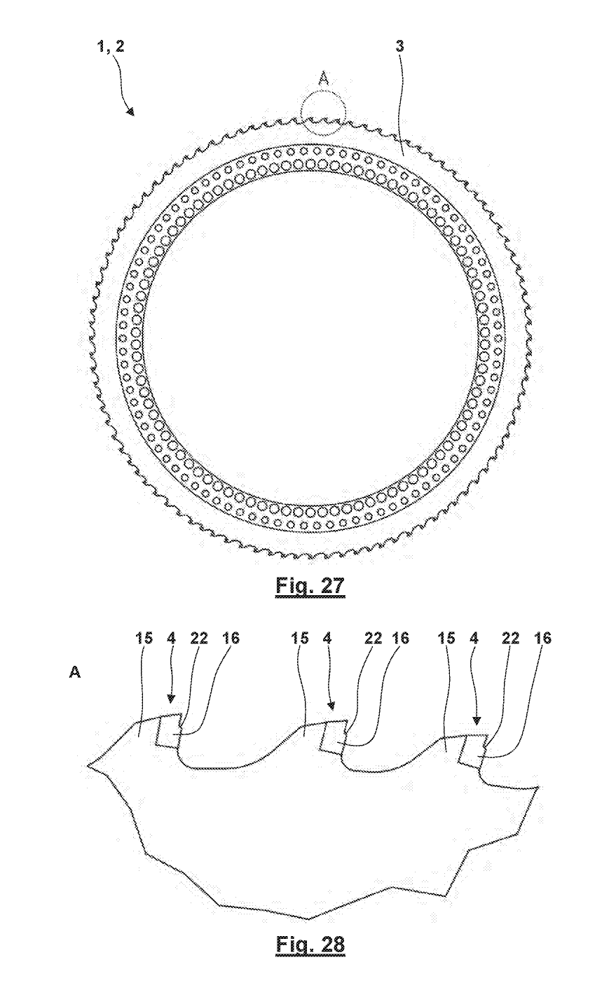

FIGS. 27 and 28 illustrate teeth 4 having inserts 16 being designed to be greater than the inserts 16 in FIG. 26. Each of these inserts 16 also includes a chip deforming element 22. The connecting surface to the protrusion 15 is designed differently, and the connection has been realized by brazing or soldering.

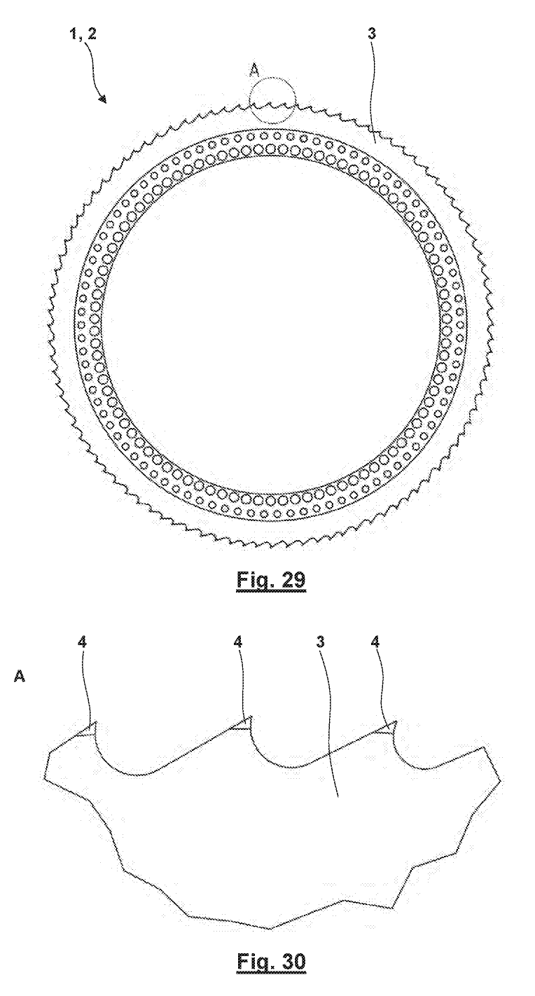

FIGS. 29 and 30 illustrate an exemplary embodiment of the saw blade 1 being designed as a bimetallic saw blade. Correspondingly, there are no protrusions and inserts. The part of the tooth 6 including the cutting portion is made of a material which is harder than the part of the tooth 4 and of the tooth supporting body 3, respectively, being located further below. Especially, the tooth supporting body 3 is made of steel, and the part of the tooth 4 including the cutting portion is made of high-speed steel.

FIGS. 31 and 32 illustrate another exemplary embodiment of the teeth 4. In this case, the tooth supporting body 3 and the teeth 4 are designed as one piece, and they are made of the same material. Especially, this material is high-speed steel.

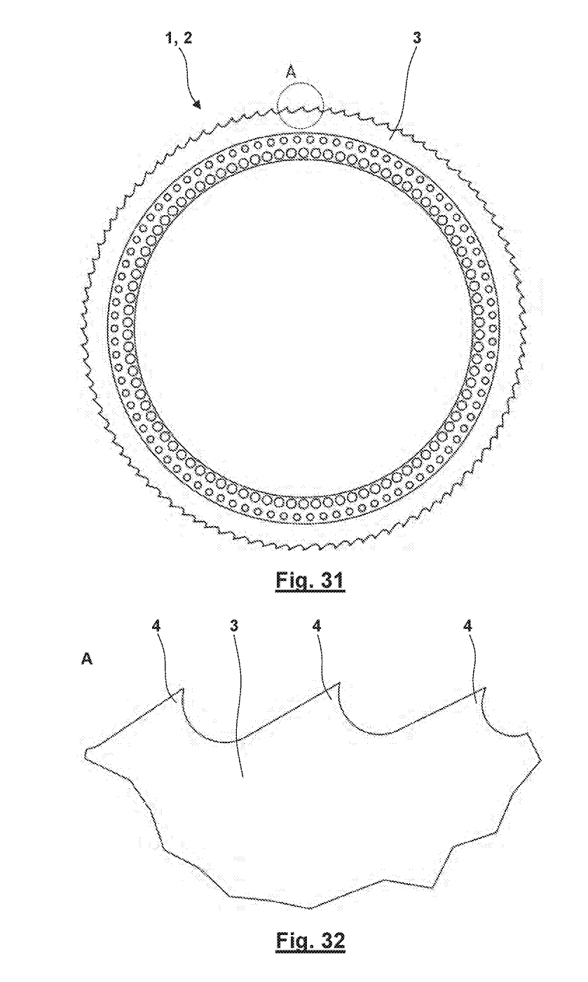

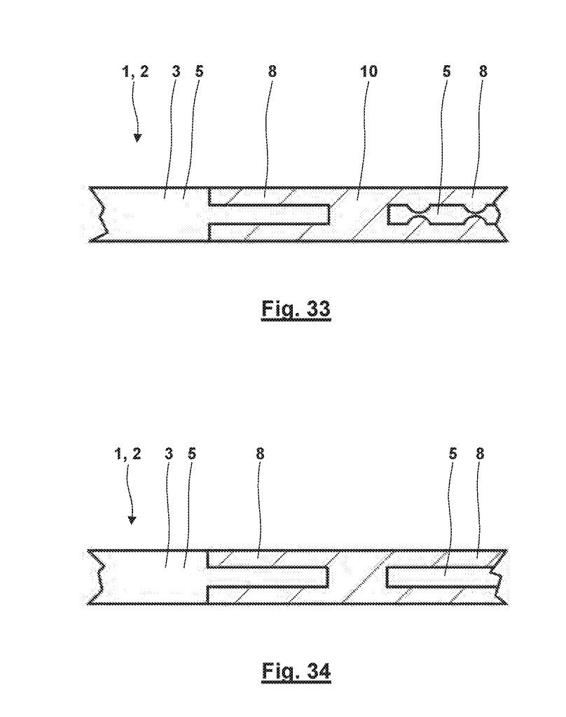

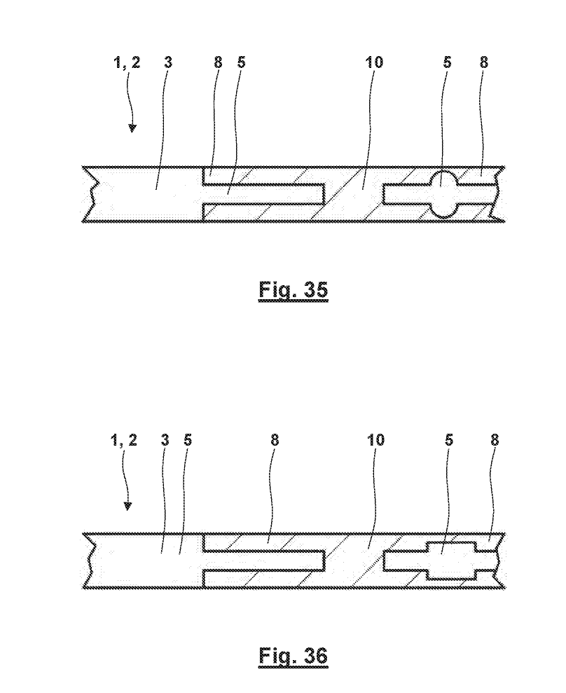

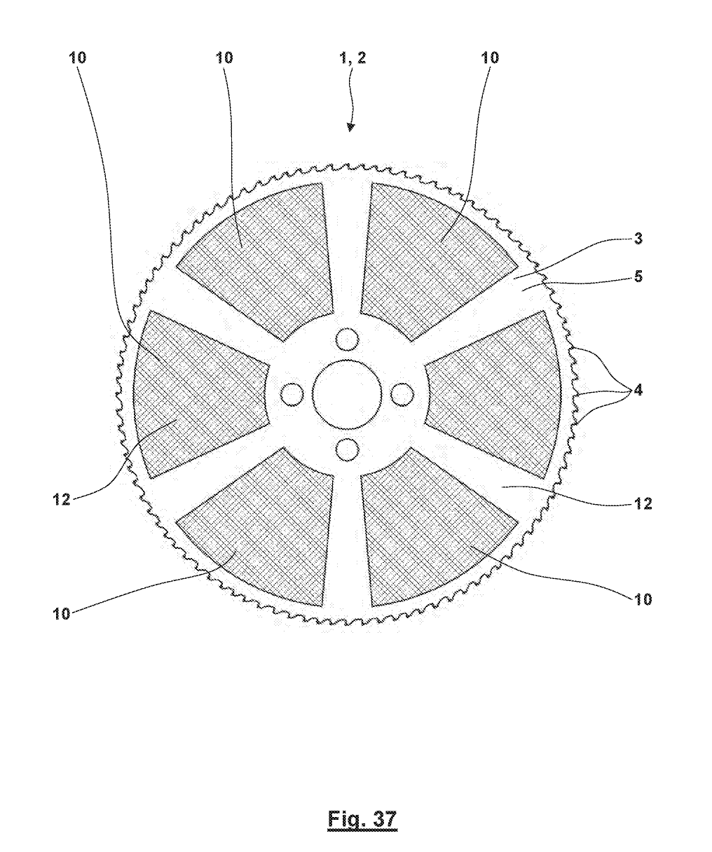

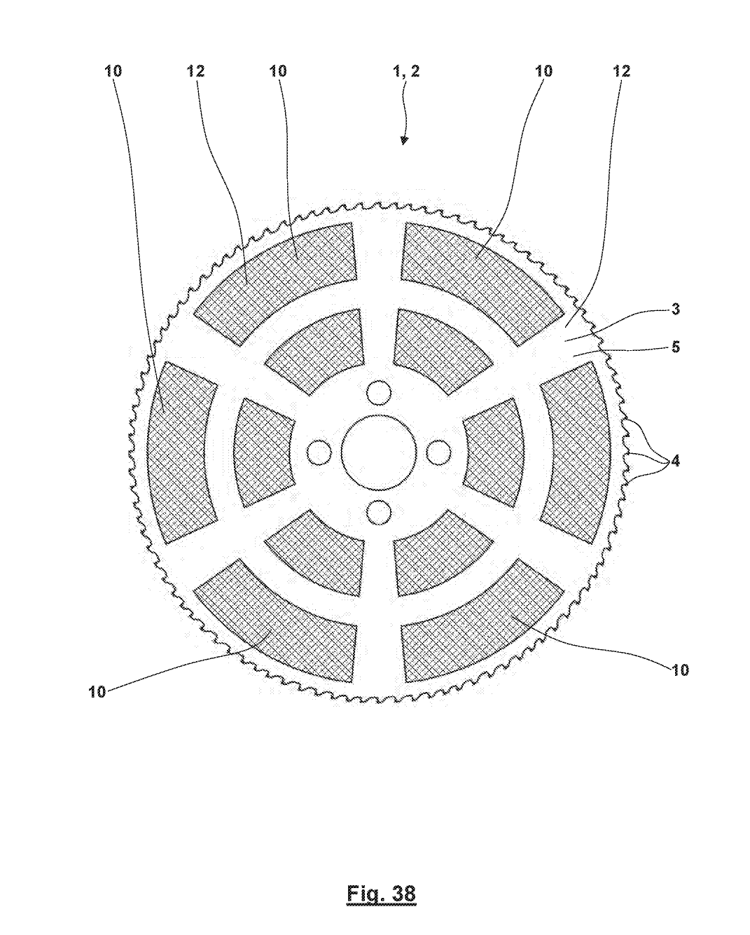

FIGS. 33 to 36 illustrate additional different embodiments of the saw blade 1 being designed as a circular saw blade 2 and especially different connecting zones between the tooth supporting body 3 and the basic body 10. In this case, not the entire radial inward portion is made of a fiber reinforced material, but instead a second ring 5 exists. This second ring 5 also includes a deepening 8 which is closed by the material of the basic body 10 in a way that the tooth supporting body 3 subjects the basic body 10 to tension. In this way, especially the following ordered structure is attained: an inner ring of steel, a middle disc of fiber reinforced material and an outer ring of steel.

FIG. 37 illustrates another exemplary embodiment of the saw blade 1 being designed as a circular saw blade 2. In this case, the tooth supporting body 3 includes a plurality of deepenings 8 being designed as segments of a circle and being spaced apart the circumference. The tooth supporting body 3 is thus designed in a spoke-like manner, the spokes being made of metal and being oriented such that their projections intersect with the center of the circular saw blade 2. In the illustrated example, the tooth supporting body 3 includes six deepenings 8. However, it could also include three or four or up to eight of such deepenings 8. The deepenings 8 are arranged to be spaced apart the circumference of the circular saw blade 2 such that the required concentricity of the saw blade 2 during sawing results.

A basic body 10 is arranged in each of these deepenings 8. The basic bodies 10 are again subjected to tension by the tooth supporting body 3. The mass of such a circular saw blade 2 is substantially reduced compared to a circular saw blade being made of steel only. The noise emissions during sawing are also substantially reduced. Furthermore, these segments of fiber reinforced material provide very good attenuation properties. Thus, the forces resulting from the driving power of the motor of the saw machine and from the cutting forces are not transmitted by the fiber reinforced material, but instead by the spoke-like tooth supporting body 3.

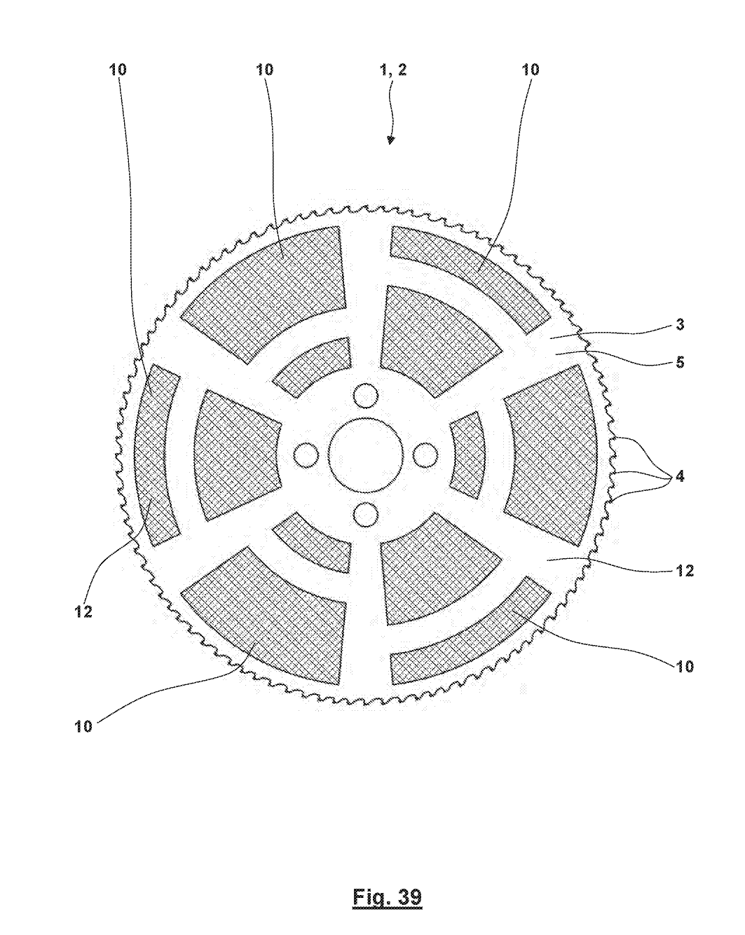

FIG. 38 illustrates another exemplary embodiment of the saw blade 1 being designed as a circular saw blade 2. In this case, other than in FIG. 37, sections of the tooth supporting body 3 are also arranged in the radial direction between the deepenings 8 and the basic bodies 10. In other words, each of the deepenings 8 according to FIG. 37 has been divided into two spaced apart deepenings 8.

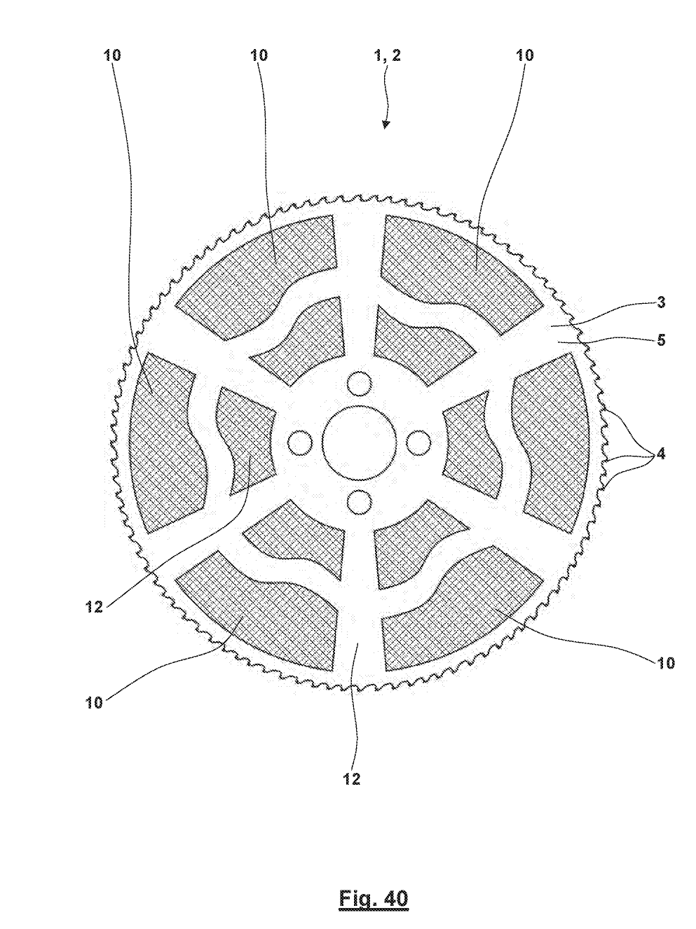

FIG. 39 illustrates another exemplary embodiment of the saw blade 1 being designed as a circular saw blade 2. In this case, the sizes of the deepenings 8 have been further varied and alternatingly arranged in the circumferential direction.

FIG. 40 illustrates another exemplary embodiment of the saw blade 1 being designed as a circular saw blade 2. In this case, the deepenings 8 and the basic bodies 10 being located therein are not designed as segments of a circle, but instead to have the shape of a sinus. This concerns the opposed boundary lines of the deepenings 8 between deepenings 8 being adjacent in a radial direction.

Due to the above-described embodiments, a low mass and good attenuation properties of the saw blade 1 are attained.

Many variations and modifications may be made to the preferred embodiments of the invention without departing substantially from the spirit and principles of the invention. All such modifications and variations are intended to be included herein within the scope of the present invention, as defined by the following claims.

I claim:

1. A method of producing a saw blade, the saw blade including a base body and a plurality of teeth, the base body including a tooth supporting body and a basic body, the teeth being arranged at the tooth supporting body, the tooth supporting body including a deepening having a size, the basic body being made of a fiber reinforced material, said method comprising the steps of:
reducing the size of the deepening of the tooth supporting body; and
connecting the tooth supporting body to the basic body to form the base body such that the deepening is closed and the tooth supporting body subjects the basic body to tension when the tooth supporting body and the basic body have the same temperature.

2. The method of claim 1, wherein the size of the deepening is reduced by selective heat treatment for obtaining a temperature difference between the basic body and the tooth supporting body.

3. The method of claim 1, wherein the tooth supporting body is cold-stretched.

4. The method of claim 2, wherein the tooth supporting body is cold-stretched.

5. The method of claim 4, wherein the tooth supporting body is cooled to reach a temperature of less than −5° C.

6. The method of claim 4, wherein the tooth supporting body is cooled to reach a temperature of between approximately −10 and −20° C.

7. The method of claim 1, wherein the size of the deepening is reduced by a pressurization of the tooth supporting body.

8. The method of claim 7, wherein the tooth supporting body is upset by between approximately 0.01 and 0.05 mm.

9. The method of claim 1, wherein the fiber reinforced material includes reinforcing fibers and a matrix material, the fibers being arranged in the matrix material as a tow such that a quasi isotropic fabric is formed.

10. The method of claim 9, wherein
the tooth supporting body includes a connecting element including a plurality of recesses; and
the basic body includes a plurality of tows of the fiber reinforced material, the tows being connected to the tooth supporting body such that the connecting element of the tooth supporting body is arranged between a plurality of these tows and the tows are connected to one another via the recesses.

11. The method of claim 10, wherein
the reinforced fibers are selected from the group consisting of metal fibers, carbon fibers and plastic fibers; and
the matrix material includes a material selected from the group consisting of plastic, ceramic and metal.

12. The method of claim 1, wherein the deepening is a through hole.

13. The method of claim 1, wherein the tooth supporting body is made of metal.

14. The method claim 1, wherein
the saw blade is designed as a circular saw blade;
the tooth supporting body is designed as a ring;
the diameter of the ring is reduced; and
the ring subjects the basic body to tension in a radial direction.

15. The method of claim 1, wherein
the saw blade is designed as a saw band; and
the tooth supporting body is designed to be elongated.

16. A saw blade, comprising:
a base body, the base body including a tooth supporting body and a basic body,
the tooth supporting body including a deepening having a size,
the basic body being made of a fiber reinforced material,
the basic body being connected to the tooth supporting body by a process which has reduced the size of the deepening of the tooth supporting body to form the base body of the saw blade such that the deepening is closed and the tooth supporting body subjects the basic body to tension when the tooth supporting body and the basic body have the same temperature; and
a plurality of teeth, the teeth being arranged at the tooth supporting body.

17. The saw blade of claim 16, wherein the tooth supporting body includes a plurality of deepenings and a plurality of spokes, the spokes being made of metal and being arranged between the deepenings, each deepening being closed by the fiber reinforced material.

18. The saw blade of claim 16, wherein the deepening is a through hole.

19. The saw blade of claim 16, wherein
the saw blade is designed as a saw band; and
the tooth supporting body is designed to be elongated.

20. The saw blade of claim 16, wherein the fiber reinforced material includes reinforcing fibers and a matrix material, the fibers being arranged in the matrix material as a tow such that a quasi isotropic fabric is formed.

21. The saw blade of claim 20, wherein
the tooth supporting body includes a connecting element including a plurality of recesses; and
the basic body includes a plurality of tows of the fiber reinforced material, the tows being connected to the tooth supporting body such that the connecting element of the tooth supporting body is arranged between a plurality of these tows and the tows are connected to one another via the recesses.

22. The saw blade of claim 21, wherein
the reinforced fibers are selected from the group consisting of metal fibers, carbon fibers and plastic fibers; and
the matrix material includes a material selected from the group consisting of plastic, ceramic and metal.

23. A saw band, comprising:
an elongated tooth supporting body, the tooth supporting body including a through hole;
a plurality of teeth, the teeth being arranged at the tooth supporting body; and
a basic body, the basic body being made of a fiber reinforced material and being connected to the tooth supporting body such that the through hole is closed and a base body is formed.

24. The saw band of claim 23, wherein the fiber reinforced material includes reinforcing fibers and a matrix material, the fibers being arranged in the matrix material as a tow such that a quasi isotropic fabric is formed.

25. The saw band of claim 24, wherein
the tooth supporting body includes a connecting element including a plurality of recesses; and
the basic body includes a plurality of tows of the fiber reinforced material, the tows being connected to the tooth supporting body such that the connecting element of the tooth supporting body is arranged between a plurality of these tows and the tows are connected to one another via the recesses.

26. The saw band of claim 25, wherein
the reinforced fibers are selected from the group consisting of metal fibers, carbon fibers and plastic fibers; and
the matrix material includes a material selected from the group consisting of plastic, ceramic and metal.

27. A band saw machine, comprising:
a saw band, including:
an elongated tooth supporting body, the tooth supporting body including a through hole,
a plurality of teeth, the teeth being arranged at the tooth supporting body, and
a basic body, the basic body being made of a fiber reinforced material and being connected to the tooth supporting body such that the through hole is closed and a base body is formed; and
two wheels,
the wheels being arranged at a distance with respect to one another,
the wheels being designed and arranged to guide and to rotatingly drive the saw band,
the distance between the wheels being designed to be adjustable such that the tooth supporting body subjects the basic body to tension when the tooth supporting body and the basic body of the saw band have the same temperature.

28. The band saw machine of claim 27, wherein the fiber reinforced material includes reinforcing fibers and a matrix material, the fibers being arranged in the matrix material as a tow such that a quasi isotropic fabric is formed.

29. The band saw machine of claim 28, wherein
the tooth supporting body includes a connecting element including a plurality of recesses; and
the basic body includes a plurality of tows of the fiber reinforced material, the tows being connected to the tooth supporting body such that the connecting element of the tooth supporting body is arranged between a plurality of these tows and the tows are connected to one another via the recesses.

30. The band saw machine of claim 29, wherein
the reinforced fibers are selected from the group consisting of metal fibers, carbon fibers and plastic fibers; and
the matrix material includes a material selected from the group consisting of plastic, ceramic and metal.
